(19) United States
(12) Patent Application Publication
(10) Pub. No.: US 2024/0397312 A1
(43) Pub. Date: Nov. 28, 2024

(54) SYSTEM FOR CONTROLLING NETWORK ACCESS OF APPLICATION ON BASIS OF DATA FLOW, AND METHOD RELATING TO SAME

(71) Applicant: PRIBIT Technology, Inc., Seoul (KR)

(72) Inventor: Young Rang KIM, Seoul (KR)

(21) Appl. No.: 18/689,775

(22) PCT Filed: Sep. 6, 2022
(86) PCT No.: PCT/KR2022/013321

§ 371 Date: Mar. 6, 2024

(30) Foreign Application Priority Data
Sep. 7, 2021 (KR) 10-2021-0119167

(51) Int. Cl. H04W 12/06; H04W 12/088

(52) U.S. Cl. CPC H04W 12/06; H04W 12/088

(57) ABSTRACT

A network system according to an embodiment disclosed in the present disclosure includes a node, a destination network, a network node, and a server. The node is configured to transmit or drop a data packet depending on whether there is data flow, by means of an access control application, delete the data flow corresponding to identification information of an ended application, when a running end event of the target application or the access control application is identified, and transmit a list of the deleted data flow to the server. The server is configured to transmit the list of the deleted data flow to the network node and collect a network node policy from the node. The network node is configured to process a data packet corresponding to the list of the deleted data flow to be no longer forwarded.

### CROSS-REFERENCE TO RELATED APPLICATION(S)

The present disclosure claims the benefit of Korean Patent Application No. 10-2021-0119167 filed on Sep. 7, 2021, with the Korean Intellectual Property Office, the disclosure of which is incorporated herein by reference in its entirety.

### TECHNICAL FIELD

Embodiments disclosed in the present disclosure relate to a system for controlling network access of an application based on data flow and a method thereof.

### DESCRIPTION OF THE RELATED ART

An Internet protocol (IP) technology is used today as a common communication technology in networks such as terminals and servers. A firewall technology using 5-tuples information (a protocol, a source IP address, a source port, a destination IP address, and destination port information) included in a data packet to perform access control in an IP network may be universally used.

Because the firewall technology serves to identify an IP address assigned to a terminal or a network node (e.g., a firewall, a router, or the like) and control the corresponding IP address to access (be inbound to) the destination network or conversely access (be outbound to) it at the network boundary, it provides a basic network access control means, thus establishing itself as a general-purpose network security solution which is essential at the network boundary with the spread of the Internet.

Because the characteristic of an access control technology using the 5-tuples information to perform access control in such an IP network is operated by a static policy, that is, a preset policy, it is difficult to manage an access grant time point and an access end time point of the corresponding IP. In an environment where various terminals access firewalls located at various boundaries, because the number of policies increases exponentially, there occurs a problem in which the policies are not collected or it is difficult to collect the policies due to concerns about a fault occurring when the purpose of use of the previously set policy is unclear. A behavior in which a stealer uses vulnerabilities in these policies to bypass and intrude the firewall.

To address such a problem, there is a technology for integrating, managing, and operating policies of a plurality of firewalls. However, because it is unable to know when a terminal starts access to the network and when it ends access to the network due to the nature of IP technology, there may be difficulty in applying the dynamic policy of granting the policy only when needed.

Because the firewall performs simple network access control based on the 5-tuples information of the IP, even if there is an authorized terminal, when the corresponding terminal is infected with malware or malicious code, it is unable to block data packet transmission for performing a malicious behavior.

### BRIEF SUMMARY

### Technical Problem

A next-generation firewall technology including a deep packet inspection (DPI) technology for inspecting a payload including substantial data other than 5-tuples information has been introduced to respond to continuously evolving network risks.

The DPI technology for inspecting the data packet provides a more improved security technology than an existing firewall because of blocking some of data packets by means of an embedded pattern DB (a rule of filtering a malicious data packet or a data packet to be blocked). However, there is a problem in which it is difficult to respond to a new risk which is not present in the pattern DB, due to the nature of the method of detecting risks using the pattern DB, like a vaccine installed on the terminal.

Particularly, because the DPI technology uses the pattern DB based on protocol information mapped according to a service port, rather than identifying an application which is a substantial communication entity of the terminal, a problem such as false negative and false positive or miss detection occurs and this leads to unknown service failures. The reality is that an administrator does not use all the pattern DBs provided by the PI technology, but only set a minimal filtering policy.

Such a problem is ultimately a limitation of the network technology stack based on the OSI 7 layer where the terminal and network operate separately. There may be a need for a method capable of identifying an application which is a substantial communication entity and controlling access depending on a network the application wants to access.

Various embodiments disclosed in the present disclosure may provide a fundamental method for performing pre-filtering and post-filtering of risk by solving a problem, such as false positive and false negative, by identifying an application which is a blind spot in network security and is a substantial communication entity, which is the firewall problem based on the static policy and the fundamental problem inherent in the next-generation firewall technology including the deep packet analysis, and transmitting only a data packet of an authorized secure application to the terminal, allowing a firewall presenting at the network boundary to access a destination network at only an access time point of the corresponding application, and accurately applying a pattern DB for inspecting the corresponding data packet when the corresponding application accesses the destination network.

### Technical Solution

A network system according to an embodiment disclosed in the present disclosure may include a node including a communication circuit, a processor operatively connected with the communication circuit, and a memory storing an access control application, a destination network the node wants to access, a network node located between the node and the destination network and configured to include a memory, and a server including a communication circuit, a processor operatively connected with the communication circuit, and a memory storing a database, the server being communicatively connected with the node and the network node. The node may be configured to transmit or drop a data packet depending on whether there is data flow based on identification information of a target application or identification information including an IP address and port information of the destination network to communicate with the destination network, by means of the access control application, delete the data flow corresponding to identification information of an ended application, when a running end event of the target application or the access control application is identified, and transmit a list of the deleted data flow to the server. The server may be configured to transmit the list of the deleted data flow to the network node and collect a network node policy from the node. The network node may be configured to process a data packet corresponding to an IP address of the node, the IP address of the destination network, and the port information of the destination network included in the list of the deleted data flow to be no longer forwarded.

According to an embodiment, the server may be configured to identify whether identification information of the access control application is included and whether it is accessible to a network node present between the destination network mapped to the identification information and a network boundary of the node, in an access policy matched with the identification information on control flow, identify whether it is accessible to a network node at the boundary of the destination network the node wants to access in the network node policy to grant access of the node, when it is accessible, and identify whether there is data flow accessible to the IP address and a port of the destination network in a data flow table, generate data flow based on the IP address of the node, the IP address of the destination network, the port information, and data packet inspection information to grant access of the application, when there is no valid data flow in the data flow table, and transmit the generated data flow to the network node and the node, and transmit data flow to the node, when there is the accessible data flow in the data flow table.

According to an embodiment, the network node may be configured to identify whether there is data flow in a data table stored in the database, based on the IP address of the node, the IP address of the destination network, and the port information, among data packets received from the node, drop the received data packet, when there is no the data flow, identify the data packet is included in an inspection target based on a data packet inspection rule database (DB) included in the data flow, when there is the data flow, forward the data packet, when it is not included in the inspection target, and perform data packet processing, when it is included in the inspection target.

According to an embodiment, the data packet processing may include inspecting whether a single data packet is identical based on the data packet inspection rule database, when a single inspection of the data packet is performed, storing the transmitted data packet in the memory of the network node up to a data packet transmission end point, when multiple inspections of the data packet are performed, and inspecting whether all the stored data packets are identical based on the data packet inspection rule database, and processing a data packet, a pattern of which is detected, depending on data packet inspection information, when it is identical to the data packet inspection rule database. The processing of the data packet may include dropping the data packet, when the data packet should be blocked, replacing the data packet based on replacement information included in the data flow and forwarding the replaced data packet, when there is a need to replace the data packet, and storing the data packet in the memory of the network node depending on a rule included in the data flow and forwarding the data packet, when there is a need to store the data packet.

According to an embodiment, the network node may be further configured to transmit a data packet inspection result to the server.

According to an embodiment, the node may be configured to receive a first user input for requesting user authentication and request user authentication for a user of the node from the server, using the communication circuit, the user authentication request including user identification information. The server may be configured to inspect whether the user who attempts access at the node is an accessible user and whether the user is included in a blacklist to identify the user is blocked, in response to the user authentication request from the node, transmit inaccessible information to the node, when the user is inaccessible or when the user is included in the blacklist, search a control flow table for control flow using transmitted control flow identification information, when the user is the accessible user, and add the user identification information to identification information of the found control flow, and return an authentication complete state and access policy information of an authenticated user to the node as a user authentication result.

According to an embodiment, the node may be configured to detect a control flow update event and request the server to update control flow and end the application or block all network access of the application, when the result of updating the control flow is inaccessible. The server may be configured to identify whether there is control flow in a control flow table based on control flow identification information requested by the node, return inaccessible information to the node, when there is no the control flow, and update an update time, when there is the control flow, and search for data flow dependent on the control flow.

According to an embodiment, the node may be configured to detect an access release event and request the server to end control flow. The server may be configured to remove control flow identified and found based on control flow identification information requested by the node and request the network node for relaying all dependent data flow to remove data flow, when the control flow is removed. The network node may be configured to remove the data flow, such that the application is in a state in which it is no longer able to transmit the data packet to the destination network.

According to an embodiment, the access control application of the node may be further configured to delete all data flow corresponding to identification information of the ended application, when the ended application is not present in a list of processes which are running to track the end of multiple executable applications.

### Advantageous Effects

According to embodiments disclosed in the present disclosure, the access application may receive data flow information (a source IP address and a destination IP address and port information) to allow the controller to transmit a data packet based on the terminal or one or more pieces of identification, an IP address assigned to the terminal through identification and authentication for the application, and an IP of the terminal identify by the controller to access the destination network. The corresponding data flow may be simultaneously propagated to a firewall present at the network boundary.

The access control application may perform the behavior of primarily granting or blocking network access of the access application depending on data flow information received from the controller. When there is no data flow received from the controller in a firewall present at the network boundary when the access control application bypasses it and transmits the data packet, the access control application may block the data packet from being transmitted to the destination network, thus basically blocking an unauthorized target from accessing the destination network when using the present patent.

Furthermore, the firewall present at the network boundary may transmit an abnormal data packet to an authorized network using a malicious code or a defect in the corresponding application, rather than direct application forgery or falsification, when a secure application authorized based on inspection information included in data flow accesses the authorized network, or the user may detect the risk of the behavior of stealing important or personal information from service resources for malicious purposes and may control access.

Particularly, because a terminal and a user or an application and network information incapable of being identified on the OSI 7 layer of an existing network are identified, it is possible to apply a data packet inspection rule DB optimized for each identification element if necessary, it is possible to minimize false negative, false positive, and miss detection using such an optimization technology, and in addition, it is possible to block and isolate access for each identified terminal or user depending on the level of the detected risk information, thus providing a more useful method to identify an application, which is a substantial data packet transmission entity, and inspect the optimized data packet, than inspecting the data packet at the network boundary.

In addition, a method capable of filtering personal information included in the data packet or extracting a data packet not to download or update important data from service resources and transmitting the data packet to the controller to use it as inspection data in the future to monitor in detail who, when, and how accessed important or sensitive data may be provided.

Furthermore, there is no longer need to access the network, a method for collecting all data flow information and the policy associated with the firewall to perform complete blocking in the network may be provided to provide a complete isolation method.

As a result, an unauthorized terminal and application or an insecure application may fundamentally block access of an unauthorized network and a data packet inspection DB optimized for a service the authorized application wants to access may be applied, thus blocking the behavior in which ransomware and malware included in a terminal with inherent vulnerabilities, particularly, which are new risk factors not detected by antivirus, antivirus, or malware detection tools, spread and attack a destination network or an important service server.

As a result, it is possible to implement a security network connection lifecycle from application network access control to threat blocking and isolation using the data flow-based accessibility control technology, a secure network connection in which the problem of applying the comprehensive policy to the static policy and the deep packet analysis of the existing firewall technology is resolved may be provided.

In addition, various effects ascertained directly or indirectly through the present disclosure may be provided.

### BRIEF DESCRIPTION OF THE SEVERAL VIEWS OF THE DRAWINGS

FIG. 1 illustrates an architecture in a network environment including a firewall according to various embodiments;

FIG. 2 describes an operation of blocking network access according to various embodiments;

FIG. 3 is a functional block diagram illustrating a database stored in a controller according to various embodiments;

FIG. 4 illustrates a functional block diagram of a node according to various embodiments;

FIG. 5 illustrates a signal sequence diagram for controller access according to various embodiments;

FIG. 6 illustrates a signal sequence diagram for user authentication according to various embodiments.

FIG. 7 illustrates a signal sequence diagram for processing network access according to various embodiments;

FIG. 8 illustrates a signal sequence diagram for forwarding a data packet according to various embodiments;

FIG. 9 illustrates a signal sequence diagram for releasing network access according to various embodiments; and

FIG. 10 illustrates a signal sequence diagram for ending application execution according to various embodiments.

### DETAILED DESCRIPTION

Hereinafter, various embodiments of the present disclosure will be described with reference to the accompanying drawings. However, it should be understood that this is not intended to limit the present disclosure to specific implementation forms and includes various modifications, equivalents, and/or alternatives of embodiments of the present disclosure.

A singular form of a noun corresponding to an item in the present disclosure may include one or plural of the items, unless the relevant context clearly indicates otherwise. In the present disclosure, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. Such terms as “1st” and “2nd,” or “first” and “second” may be used to simply distinguish a corresponding component from another, and does not limit the components in other aspect (e.g., importance or order). When it is mentioned that a certain component (for example, first component) is coupled or connected to another component (for example, second component) with a term such as “operatively” or “communicatively” or without such a term, it indicates that the first component may be directly (for example, in a wired manner), wirelessly or through a third component.

Each (e.g., a module or a program) of the components described in the present disclosure may include a single entity or a plurality of entities. According to various embodiments, one or more of the above-described components or operations may be omitted, or one or more other components or operations may be added. Alternatively or additionally, a plurality of components (e.g., modules or programs) may be integrated into one component. In this case, the integrated component may perform one or more functions of each component of the plurality of components in the manner same as or similar to being performed by the corresponding component of the plurality of components prior to the integration. According to various embodiments, operations performed by the module, the program, or another component may be carried out sequentially, in parallel, repeatedly, or heuristically, or one or more of the operations may be executed in a different order or omitted, or one or more other operations may be added.

As used in the present disclosure, the term “module” may include a unit implemented in hardware, software, or firmware, and may interchangeably be used with other terms, for example, “logic,” “logic block,” “part,” or “circuitry”. A module may be an integral part, or a minimum unit or portion thereof, adapted to perform one or more functions. For example, according to an embodiment, the module may be implemented in the form of an application-specific integrated circuit (ASIC).

Various embodiments of the present disclosure may be implemented as software (e.g., a program or an application) including one or more instructions which are stored in a storage medium (e.g., a memory) readable by a machine. For example, a processor of the machine may invoke at least one of the stored one or more instructions from the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to various embodiments disclosed in the present disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least a part of the computer program product may be temporarily generated or at least temporarily stored in the machine-readable storage medium, such as a memory of the manufacturer's server, a server of the application store, or a relay server.

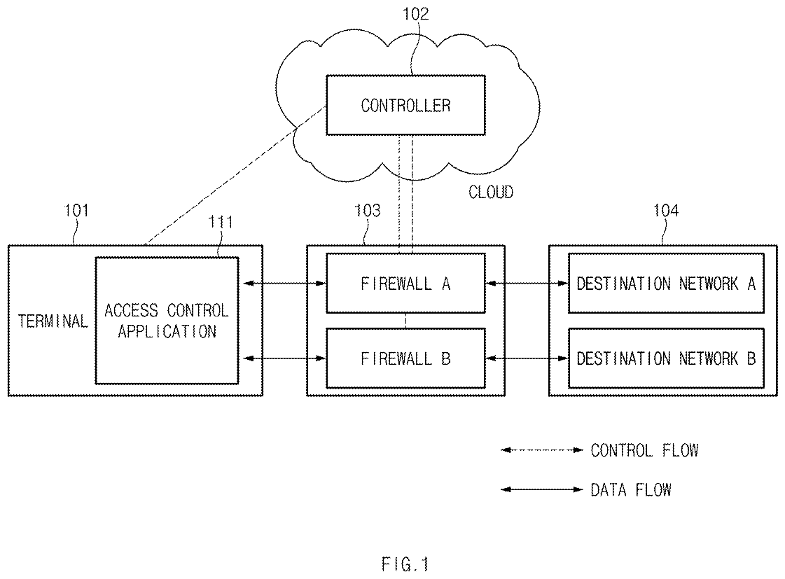

FIG. 1 illustrates an architecture in a network environment including a firewall according to various embodiments.

Referring to FIG. 1, the number of nodes 101, firewalls 103, and destination networks 104 is not limited to the number shown in FIG. 1. For example, a controller 102 may manage the one or more nodes 101, the one or more firewalls 103, and the one or more destination networks 104. In the present disclosure, the “firewall” may be replaced with the “route,” and the firewall and route may be referred to as a “network node.”

According to an embodiment, a data flow-based accessibility control technology may provide a structure in which communication is possible only when there is data flow authorized by the controller 102 for the node 101 to access a target network and may provide a structure in which the node 101 is unable to communicate only when there is no data flow.

The node 101 may include an access control application 111 for all network access control for an application in the node 101 and a network driver (not shown).

The node 101 may identify whether it is accessible from the controller 102 when network access occurs and may transmit a data packet to the firewall 103 which is present at the boundary of an access target network through data flow information generated by the controller 102 only when it is accessible.

The firewall 103 may identify 5-tuples information among the received data packets. When there is data flow information corresponding to a source IP address, a destination IP address, and destination port information and when a data packet inspection should be performed for the data flow information, the firewall 103 may inspect the data packet and may then forward a normal data packet to a destination network.

The controller 102 may provide a method for always maintaining a secure network state, for example, controlling network access of the node 101, identifying the firewall 103 the node 101 wants to access, removing the generated data flow depending on a security event received from each node 101 and the firewall 103, and isolating the node 101 by means of a blacklist.

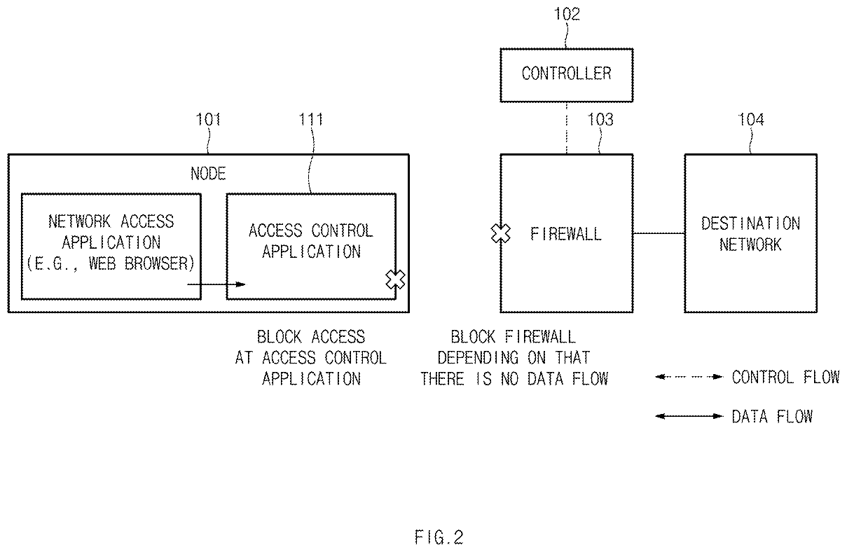

FIG. 2 describes an operation of blocking network access according to various embodiments.

When a node 101 does not access a controller 102 through an access control application, as a data packet transmitted to a network is blocked by a network driver and a kernel stage of an operating system, any data packet except for the access control application is not transmitted to the network.

For a non-management terminal in which the access control application is not installed among the nodes 101 to access a destination network 104, a network access application (referred to as a “target application”) may transmit an unauthorized data packet to the network. However, because the firewall 103 present at the network boundary blocks all data packets in which there is no authorized data flow and substantially blocks a data packet of the node 101, particularly, a data packet for generating a TCP session, the node 101 may be in a state in which it is unable to reach the target network, that is, an isolated state.

Particularly, compared to gateway-based access control, the firewall 103 may not generate a tunnel and may control access of a data packet through a predetermined policy. Furthermore, when the access control application 111 of the node 101 is ended, the controller 102 may collect a set policy, thus preventing a malicious application from subsequently attempting access.

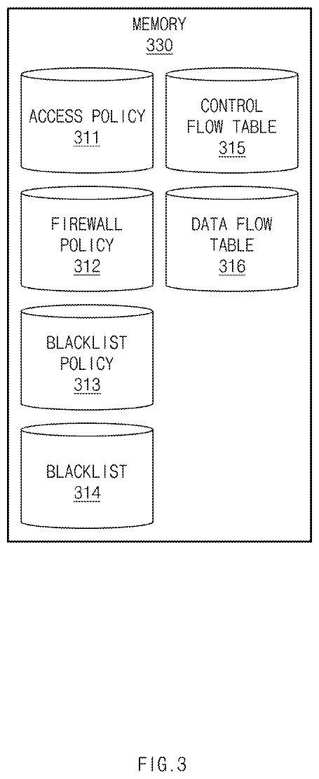

FIG. 3 is a functional block diagram illustrating a database stored in a controller (e.g., a controller 102 of FIG. 2) according to various embodiments.

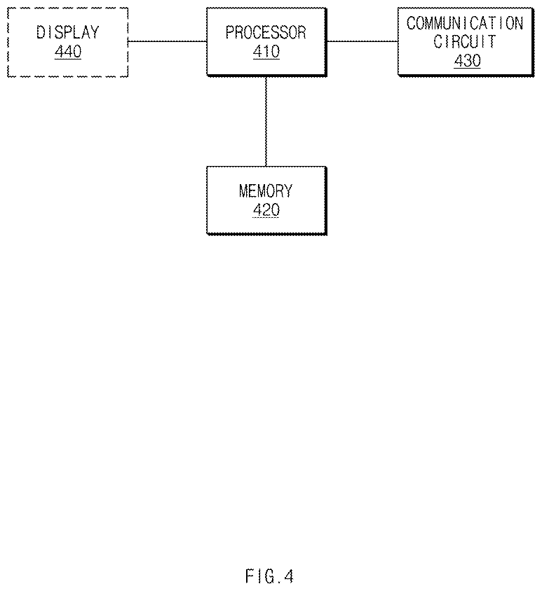

FIG. 3 illustrate only a memory 330. However, the controller may further include a communication circuit (e.g., a communication circuit 430 of FIG. 4) for performing communication with an external electronic device and a processor (e.g., a processor 410 of FIG. 4) for controlling the overall operation of the controller.

Referring to FIG. 3, the controller may store databases 311 to 316 for controlling network access and data transmission in the memory 330.

Because an administrator is able to access the controller 102 and set an access-oriented policy for controlling access between a source and a destination, more precise network access control is possible than the existing firewall 103.

The access policy database 311 may include an identified network and a network and service to which the node 101, a user, an unidentified user (a guest), an application, or the like is accessible, and data packet inspection information and may identify a network identified based the corresponding policy when the node 101 requests network access, whether the node 101, the user, the application, or the like is accessible to the target network and service and whether there is a need to inspect a data packet, a data packet inspection scheme, or data packet inspection information.

The firewall policy database 312 may include information of the firewall 103 present at the corresponding network boundary when the source node (the node 101) accesses the destination network on a connection path depending the policy and may provide information of the firewall 103 for accessing the target network or the node based on the corresponding policy when the node 101 requests network access.

The blacklist policy database 313 may set a blacklist registration policy for permanently or temporarily access of the node 101 based on a risk and a cycle of occurrence of a security event among security events periodically collected from the node 101 or the firewall 103 or information (the node 101, an IP address, a MAC address, a user, or the like) identified through a behavior analysis or the like.

The blacklist database 314 may include the node 101, the IP address, the MAC address, the user, or the like, the access of which is blocked by the policy. When the node 101 is included in the corresponding list when requesting to access the controller 102, because the access request is denied, it may be in a completely isolated state in which network access is impossible.

The control flow table 315 may be a kind of session table for managing flow generated between the node 101 and the controller 102. When the node 101 successfully accesses the control 101, control flow and identification information for identifying the control flow may be generated and information, such as an IP address, an ID of the node 101, and a user ID identified when accessing and authenticating the controller 102, may be included in the control flow.

Control flow identification information transmitted when the node 101 requests the network access and each of pieces of identification information included in control flow found using the corresponding identification information may be mapped to an access policy to be used as information for determining whether it is accessible and whether to generate data flow.

The node 101 should update the expiration time of the control flow on a periodic basis. When the update is not performed during a certain time, the control flow may be removed. Furthermore, the control flow may be removed, when there is a need to immediately block access depending on a risk level of the security event collected from the node 101 and the firewall 103 or depending on the access end request of the node 101. Because all the generated data flow is collected when the control flow is removed, all access of the node 101 may be blocked.

The data flow table 316 may be a table for managing flow in which a detailed data packet is transmitted between the node 101 and the firewall 103, which may manage flow for each TCP session in a tunnel generated for each node 101 or IP or for each application of the source node 101, and in more detailed management units. For data flow dependent on a data flow ID for identifying it and control flow, the data flow table 316 may include detailed management unit information such as dependent control flow identification information, application identification information for identifying data flow of an authorized target, a source IP address, a destination IP address, and a service port.

Furthermore, the data packet inspection information may include whether to inspect a data packet, a data packet inspection method (e.g., an inspection of a single packet, an inspection of a plurality of packets, packet replacement, packet copying), a pattern or rule DB information to be applied when inspecting the data packet, or identification information to be applied to the corresponding data packet inspection in a data packet inspection rule database (DB) previously stored in the firewall 103.

The structure of the data flow table 316 included in the controller 102 may be applied to the node 101 and the firewall 103 or the destination node in a same manner.

FIG. 4 illustrates a functional block diagram of a node according to various embodiments.

Referring to FIG. 4, the node may be a node 101, a firewall 103, or a destination network 104 and may include a processor 410, a memory 420, and a communication circuit 430. According to an embodiment, the node may further include a display 440 for performing an interface with a user.

The processor 410 may control the overall operation of the node 101. In various embodiments, the processor 410 may include one processor single core or may include a plurality of processor cores. For example, the processor 410 may include a multi-core such as a dual-core, a quad-core, or a hexa-core. According to embodiments, the processor 410 may further include a cache memory located internally or externally. According to various embodiments, the processor 410 may be configured with one or more processors. For example, the processor 410 may include at least one of an application processor, a communication processor, or a graphical processing unit (GPU).

All or a portion of the processor 410 may be electrically or operatively coupled with or connected to another component (e.g., the memory 420, the communication circuit 430, or the display 440) in the node. The processor 410 may receive commands of other components of the node, may interpret the received commands, and may perform calculation or may process data, depending on the interpreted commands. The processor 410 may interpret and process a message, data, an instruction, or a signal received from the memory 420, the communication circuit 430, or the display 440. The processor 410 may generate a new message, data, instruction, or signal based on the received message, data, instruction, or signal. The processor 410 may provide the memory 420, the communication circuit 430, or the display 440 with the processed or generated message, data, instruction, or signal.

The processor 410 may process data or a signal which is generated or occurs by a program. For example, the processor 410 may request an instruction, data, or a signal from the memory 420 to run or control the program. The processor 410 may record (or store) or update an instruction, data, or a signal in the memory 420 to run or control the program.

The memory 420 may store an instruction to control the node, a control instruction code, control data, or user data. For example, the memory 420 may include at least one of an application program, an operating system (OS) (e.g., Microsoft Windows, Google Android, Apple iOS, MacOS, or the like), middleware, or a device driver.

The memory 420 may include one or more of a volatile memory or a non-volatile memory. The volatile memory may include a dynamic random access memory (DRAM), a static RAM (SRAM), a synchronous DRAM (SDRAM), a phase-change RAM (PRAM), a magnetic RAM (MRAM), a resistive RAM (RRAM), a ferroelectric RAM (FeRAM), or the like. The non-volatile memory may include a read only memory (ROM), a programmable ROM (PROM), an electrically programmable ROM (EPROM), an electrically erasable programmable ROM (EEPROM), a flash memory, or the like. The memory 420 may further include a non-volatile medium such as a hard disk drive (HDD), a solid state disk (SSD), an embedded multi media card (eMMC), or universal flash storage (UFS).

According to an embodiment, the memory 420 may store a portion of information included in a memory (e.g., a memory 330 of FIG. 3) of the controller 102.

The communication circuit 430 may establish a wired or wireless communication connection between the terminal and an external electronic device (e.g., the controller 102 of FIG. 2) and may support to perform communication through the established connection. According to an embodiment, the communication circuit 430 may include a wireless communication circuit (e.g., a cellular communication circuit, a short-range wireless communication circuit, or a global navigation satellite system (GNSS) communication circuit) or a wired communication circuit (e.g., a local area network (LAN) communication circuit or a power line communication circuit) and may communicate with the external electronic device using a corresponding communication module among them over the short-range communication network, such as Bluetooth, WiFi direct, or infrared data association (IrDA), or the long-range wireless communication network, such as a cellular network, the Internet, or a computer network. The above-mentioned several types of communication circuits 430 may be implemented as one chip or may be respectively implemented as separate chips.

The display 440 may visually output content, data, or a signal. In various embodiments, the display 440 may display image data processed by the processor 410. According to embodiments, the display 440 may be coupled with a plurality of touch sensors (not shown) capable of receiving a touch input or the like to be configured with an integrated touch screen. When the display 440 is configured with the touch screen, the plurality of touch sensors may be arranged over the display 440 or under the display 440.

Meanwhile, a server (e.g., a controller 102) according to an embodiment may include the processor 410, the memory 420, and the communication circuit 430. The processor 410, the memory 420, and the communication circuit 430 included in the server may be substantially the same as the processor 410, the memory 420, and the communication circuit 430, which are described above.

### Network Access Control of Terminal

A user may install and run an application for performing network access control of the node 101.

### Controller Access

When running the access control application to access the controller 102, the user may enter access information and may click on an access button.

The controller 102 may inspect whether information (a type of the corresponding terminal, position information of the corresponding terminal, an environment of the corresponding terminal, a network including the terminal, and the like) requested for access by the access control application is accessible by a policy and whether the node 101 and network identification information (terminal identification information, an IP address, a MAC address, or the like) are included in a blacklist to identify whether the node 101 is accessible, may generate control flow, when it is accessible, and may transmit the generated control flow identification information to the node 101.

When the node 101 is inaccessible, the access control application may display an inaccessible message and an inaccessible reason on a screen.

When it normally accesses the controller 102, it is identified whether all network access requests subsequently generated by the node 101 are authorized by the controller 102. Because user authentication is not performed in a current stage, an access policy corresponding to an unidentified user (a guest) may be applied.

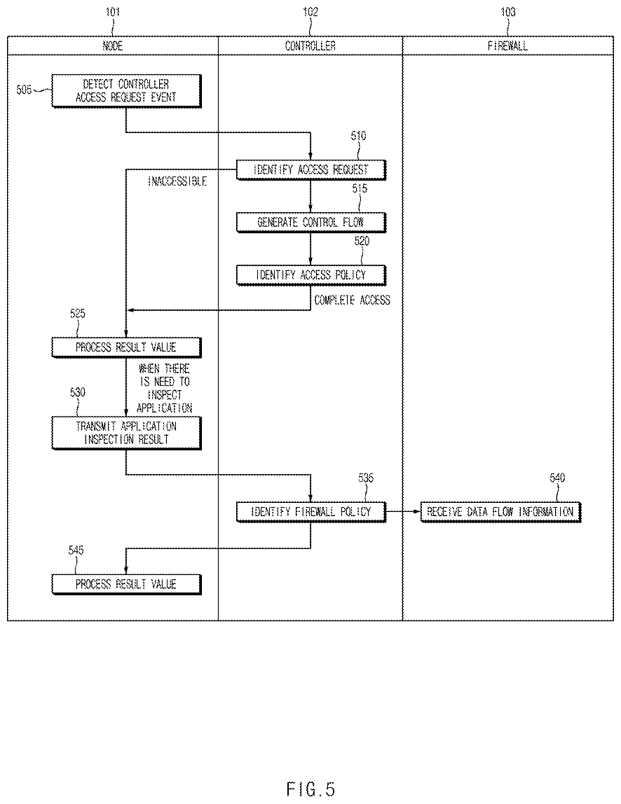

FIG. 5 illustrates a signal sequence diagram for controller access according to various embodiments.

In operation 505, a node 101 may detect a controller access request event. An access control application 111 of the node 101 may request to access a controller 102 to generate control flow (control data packet flow and a series of sessions) with the controller 102.

For example, the controller 102 may identify whether information (e.g., a type of the corresponding node 101, position information of the corresponding node 101, an environment of the corresponding node 101, a network including the corresponding node 101, access control application information, and the like) requested for access by the access control application 111 of the node 101 and/or whether terminal and network identification information (terminal identification information, an IP address, a MAC address, or the like) is included in a blacklist to identify whether the node 101 is accessible.

When it is inaccessible or is included in the blacklist, inaccessible information may be transmitted.

In operation 515, for the accessible node 101, control flow may be generated, control flow identification information may be generated in the form of a random number, and node 101 and network identification information (identification information of the node 101, an IP address, a MAC address, or the like) may be entered to be added to a control flow table 315.

In operation 520, the controller 102 may generate accessible application whitelist information, in an access policy matched with the identified information (the node 101, source network information, or the like) and may return control flow identification information for identifying control flow and an application whitelist generated through the above process, in an access complete state and when subsequently requesting user authentication of the node 101 and continuously updating information of the node 101, as the accessed result.

When it is inaccessible, the controller 102 may transmit the inaccessible result to the node 101.

In operation 525, the node 101 may process an access request result value received from the controller 102.

When it is inaccessible, the execution of the access control application may be stopped and ended, or a related error message may be displayed.

In operation 530, when receiving the application whitelist from the controller 102, the node 101 may identify whether the corresponding application is installed in the node 101 and may transmit the result of performing the inspection of whether there are integrity and safety of the corresponding application (e.g., whether the application is forged or falsified, code signing inspection, fingerprint inspection, or the like) depending on a validation policy, for the application which is present.

In operation 535, when it is accessible, it may be identified whether it is accessible to a firewall 103 at the boundary of a destination network the corresponding node 101 wants to access in a firewall policy 312 to grant the access of the node 101 connected with the corresponding network and it may be identified whether there is data flow information accessible to the corresponding destination IP address and port in a data flow table 316.

When there is no valid data flow information in the data flow table 316, data flow information may be generated based on a source IP address, a destination IP address and port information, and data packet inspection information to grant access of the corresponding application and the corresponding information may be transmitted to each of the identified firewall 103 and the node 101.

When there is accessible data flow information in the data flow table 316, the corresponding information may be transmitted to the node 101.

In operation 540, the firewall 103 may receive data flow information from the controller 102.

In operation 545, the node 101 may process an access request result value received from the controller 102.

### User Authentication

The controller 102 may inspect whether the corresponding user is an accessible user and is included in a blacklist based on information (user identification information and a password, reinforced authentication information, or the like) requested for authentication by the access control application to identify whether the corresponding user is blocked and may complete an authentication procedure, when he or she is accessible, thus adding user identification information to control flow.

When the user authentication fails, the access control application may display an inaccessible message and an inaccessible reason on a screen.

When the user is normally authenticated, an access policy corresponding to the authenticated user and it may be identified whether network access is authorized.

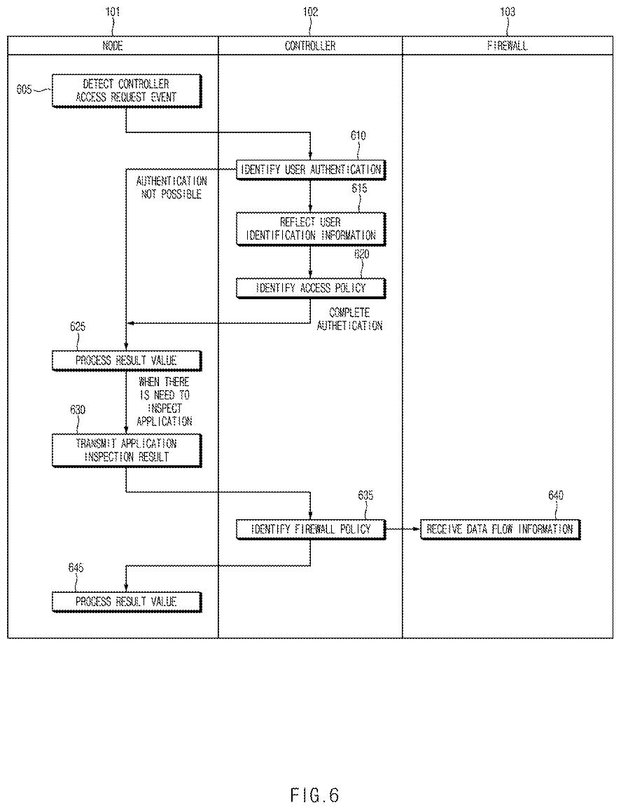

FIG. 6 illustrates a signal sequence diagram for user authentication according to various embodiments.

In operation 605, a node 101 may detect a user authentication request event. An access control application 111 may perform user authentication to be assigned the detailed access right of a network and may transmit user identification information and a password or authentication information by a reinforced authentication method.

In operation 610, the controller 102 may inspect whether the corresponding user is an accessible user and is included in a blacklist based on information (user identification information and a password, reinforced authentication information, or the like) requested for authentication by the access control application 111 to identify the corresponding user is blocked.

When he or she is inaccessible or is included in the blacklist, inaccessible information may be transmitted.

In operation 615, when there is the accessible user, a control flow table 315 may be searched for control flow using the transmitted control flow identification information and user identification information (user identification information) may be added to identification information of the found control flow.

The controller 102 may return an authentication complete state and access policy information of the authenticated user as the result of the user authentication.

In operation 620, the controller 102 may generate accessible application whitelist information, in an access policy matched with the identified information (the node 101, source network information, user identification information, or the like) and may return control flow identification information for identifying control flow and an application whitelist generated through the above process, in an access complete state and when subsequently requesting user authentication of the node 101 and continuously updating information of the terminal information, as the accessed result. When he or she is inaccessible, the controller 102 may transmit the inaccessible result to the node 101.

In operation 625, the node 101 may process an access request result value received from the controller 102. When he or she is inaccessible, the execution of the access control application may be stopped and ended, or a related error message may be displayed.

In operation 630, when receiving the application whitelist from the controller 102, the node 101 may identify whether the corresponding application is installed in the node 101 and may transmit the result of performing the inspection of whether there are integrity and safety of the corresponding application (e.g., whether the application is forged or falsified, code signing inspection, fingerprint inspection, or the like) depending on a validation policy, for the application which is present.

In operation 635, when he or she is accessible, it may be identified whether it is accessible to a firewall 103 at the boundary of a destination network the corresponding node 101 wants to access in a policy of the firewall 103 to grant the access of the node 101 connected with the corresponding network and it may be identified whether there is data flow information accessible to the corresponding destination IP address and port in a data flow table 316.

When there is no valid data flow information in the data flow table 316, data flow information may be generated based on a source IP address, a destination IP address and port information, and data packet inspection information to grant access of the corresponding application and the corresponding information may be transmitted to each of the identified firewall 103 and the node 101.

When there is accessible data flow information in the data flow table 316, the corresponding information may be transmitted to the node 101.

In operation 640, the firewall 103 may receive data flow information from the controller 102.

In operation 645, the node 101 may process an access request result value received from the controller 102.

### Application Execution and Access Web Address Input

When all applications of the node 101 want to perform network access, they may be controlled by the access control application.

The access control application may include a part which operates as a kernel and a network driver to control the network access of all the applications.

As an example of the network access control of the application, an Internet browser may be executed to enter and call a web address to be accessed.

### Access Target Identification and Data Packet Transmission Control

When the network access request is input, the access control application may identify an application which requests access and a destination IP address or service port information and may identify whether there is valid data flow information capable of being used as the corresponding identification information in the data flow table 316.

The data flow table 316 may provide information for determining whether it is able to transmit a data packet for each access and management unit.

When there is the data flow information capable of being used, the data packet may be transmitted.

When there is no data flow information, a validation procedure may be performed according to a validation policy. The validation may perform a procedure for inspecting whether there are integrity and safety of the application which requests the access (e.g., whether an application is forged or falsified, code signing inspection, fingerprint inspection, or the like) and previously identifying the access application and an access target IP address and port are accessible depending on the access policy received from the controller 102.

When the validation fails, the data packet may be dropped and the inaccessible message and the inaccessible reason may be displayed on the access control application.

When the validation succeeds, the node 101 may perform a request to access the controller 102 and may transmit each of pieces of identification information (the access application, the access target IP address, the service port information, or the like) upon the request.

The controller 102 may identify whether identification information requested for access (the access application, the access target IP address, the service port information, or the like) is included and whether it is accessible, in the access policy matched with the identified information (the node 101, the user, the source network information, or the like) on the control flow.

When it is inaccessible, the controller 102 may transmit an inaccessible result to the node 101 and the access control application may drop the corresponding data packet and may display an inaccessible message and an inaccessible reason.

When it is accessible, data flow information for granting the corresponding data packet may be transmitted to the firewall 103 which is present at the boundary of the destination network.

The access control application may identify an access request result value received from the controller 102.

Receiving the data flow information, the access control application may transmit the data packet to a service server. The firewall 103 which is present at the boundary of the destination network may identify whether there is valid data flow based on the source IP address and the destination IP address and port based on 5-tuples information of the received data packet and may drop the data packet when it is not valid.

When there is the valid data flow, the data packet may be forwarded.

Through such a procedure, the application may be in a state in which it is basically blocked with the destination network. An environment in which only a data packet included in the data flow table 316, which is granted through the authorization process of the controller 102 and the data packet forwarding process of the firewall 103, is able to be transmitted may be provided.

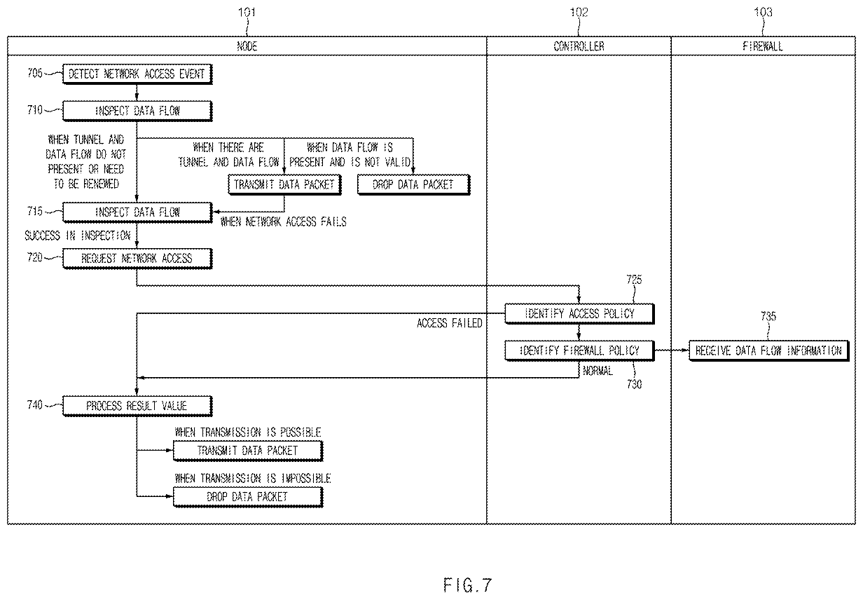

FIG. 7 illustrates a signal sequence diagram for processing network access according to various embodiments.

In operation 705, a node 101 may detect a network access event.

In operation 710, when an access control application 111 should perform communication with a service server, it may identify whether there is data flow information based on application identification information, a destination IP address, and port information to communicate with the corresponding service server.

When the data flow is present, but is not valid (e.g., it is impossible to transmit a data packet), the data packet may be dropped.

When there is the data flow, the data packet may be transmitted.

In operation 715, when there is no data packet or there is a need to update the data packet as an authentication time point expires and when the data flow should be updated by other matters, a validation procedure may be performed depending on a validation policy. The validation may include an inspection of which there are integrity and safety of the access application (e.g., whether the application is forged or falsified, code signing inspection, fingerprint inspection, or the like).

In operation 720, the access control application 111 may perform a network access request from the controller 102 based on control flow identification information for identifying control flow generated with the controller 102 before the network access event, application identification information, and a destination IP address and port information of a server to be accessed.

In operation 725, the controller 102 may identify whether identification information requested for access (an application, a destination IP address, service port information, and the like) is included and whether it is accessible to a firewall 103 which is present between a destination server mapped to the corresponding identification information and a network boundary, in an access policy matched with the identified information (a terminal, a user, source network information, or the like) on the control flow.

When it is inaccessible, the controller 102 may transmit the inaccessible result to the node 101.

In operation 730, when it is accessible, it may be identified whether it is accessible to the firewall 103 at the boundary of a destination network the corresponding node 101 wants to access in a policy of the firewall 103 to grant the access of the node 101 connected with the corresponding network and it may be identified whether there is data flow information accessible to the corresponding destination IP address and port in a data flow table 316.

When there is no valid data flow information in the data flow table 316, data flow information may be generated based on a source IP address, a destination IP address and port information, and data packet inspection information to grant access of the corresponding application and the corresponding information may be transmitted to each of the identified firewall 103 and the node 101.

When there is accessible data flow information in the data flow table 316, the corresponding information may be transmitted to the node 101.

In operation 735, the firewall 103 may receive data flow information from the controller 102.

In operation 740, the access control application 111 may process an access request result value received from the controller 102.

When it fails in network access, the data packet may be dropped.

When it is accessible based on data flow which is previously present, the data packet may be transmitted.

### Data Packet Forwarding Control of Firewall

When receiving the data packet, the firewall 103 may identify the data packet presenting in the data flow is received.

The data flow information received from the controller 102 may include a source IP address, a destination IP address, and port information. For the data packet which is not present in the data flow, the data packet may be dropped.

When there is valid data flow and when there is no need to perform a data packet inspection, the data packet may be forwarded.

When the data packet inspection should be performed, the data packet may be inspected.

When the single inspection of the data packet is performed, it may be inspected whether a single data packet is identical based on data packet inspection rule DB information.

When multiple inspections are performed, the transmitted data packet may be stored in a memory up to a data packet transmission end point and it may be inspected whether all the stored data packets are identical based on the data packet inspection rule DB information.

When it is identical to the data packet inspection rule database (DB), it may be identified whether to block a data packet, a pattern of which is detected, whether to collect the data packet as another information, or whether separately copying the data packet, depending on the data packet inspection information.

When the data packet should be blocked, the corresponding data packet may be dropped.

When information of the data packet should be replaced, a portion detected from the corresponding data packet may be replaced with replacement information included in the data packet rule DB to forward the data packet.

When the data packet should be separately copied, the corresponding data packet may be separately copied to a disc or a memory to be forwarded.

The firewall 103 may transmit the data packet inspection result or the stored information to the controller 102.

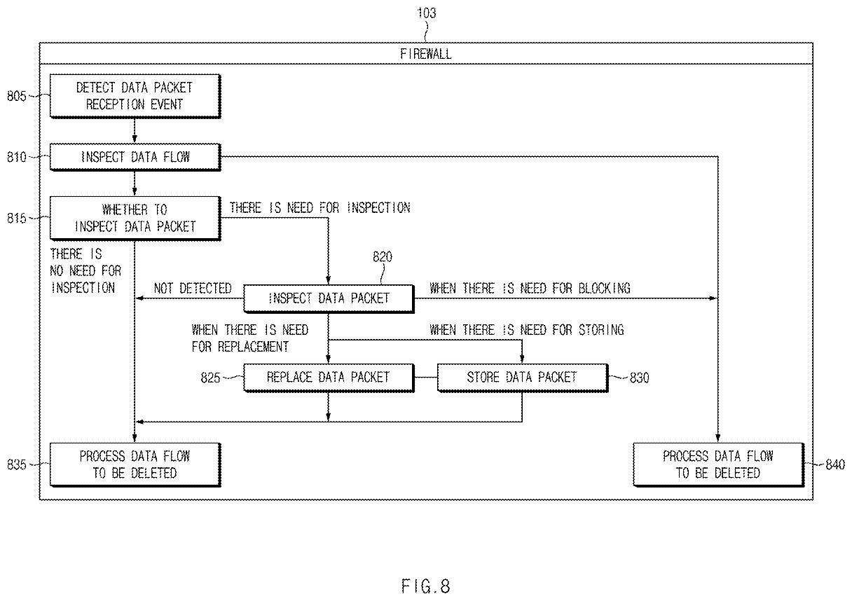

FIG. 8 illustrates a signal sequence diagram for forwarding a data packet according to various embodiments.

In operation 805, a node 101 may detect a network access event.

In operation 810, when receiving a data packet, a firewall 103 may identify whether there is data flow capable of being forwarded in a data flow table 316 based on a source IP address, a destination IP address, and destination port information included in 5-tuples information of an Internet protocol (IP).

When there is no data packet, the corresponding data packet may be dropped.

In operation 815, it may be identified whether there is a need to inspect the data packet for the corresponding data flow information.

When the inspection is not required, the data packet may be forwarded.

In operation 820, it may be identified whether the corresponding data packet is included in an inspection target by means of a data packet inspection rule DB included in data flow information.

The data packet inspection rule DB may be included the data flow information.

When there is a huge amount of data packet inspection rule DB, the data packet inspection rule DB may be selected and applied based on identification information for being selectively applied to inspect the corresponding data packet in the data packet inspection rule DB previously stored in the firewall 103.

If necessary, the corresponding procedure may inspect a single data packet or a plurality of data packets.

When it is not included in the data packet inspection target, the data packet may be forwarded (operation 835).

When it is included in the data packet inspection target, data packet processing may be performed.

In operation 825, when there is a need to replace the data packet, the corresponding data packet may be replaced by means of replacement information or a rule included in the data flow information.

In operation 830, when there is a need to store the data packet, the data packet may be stored in the memory or the disc according to the rule included in the data flow information and may be forwarded (operation 835).

In operation 840, when there is a need to block the data packet, the corresponding data packet may be dropped.

### Network Access Release

When a user does not need network access any longer or when he or she ends or restart the node 101, he or she may release previously generated data flow information through an access release procedure.

Because the node 101 in which the data flow information is released is unable to access a network using existing data flow information, it may be in a state in which it is isolated from the network.

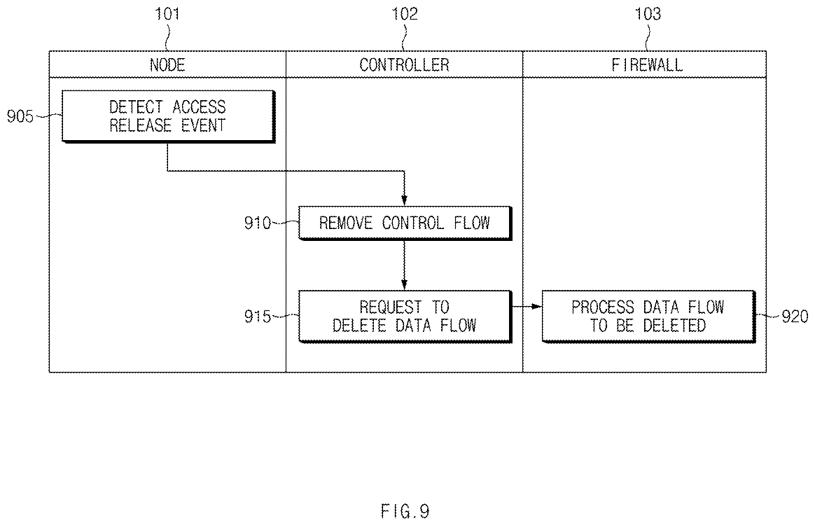

FIG. 9 illustrates a signal sequence diagram for releasing network access according to various embodiments.

In operation 905, a node 101 may detect an access release event. When an application is ended or does not use network access any longer and when an access end request is generated based on information identified from an interworking system, a control flow end request may be performed from the controller 102.

In operation 910, the controller 102 may remove control flow identified and found based on control flow identification information requested by the node 101.

In operation 915, when the control flow is removed, the corresponding data flow may be requested to be removed from a firewall 103 which relays all dependent data flow.

In operation 920, the firewall 103 may remove the data flow, such that the corresponding application may be in a state in which it is no longer able to transmit a data packet to a destination network.

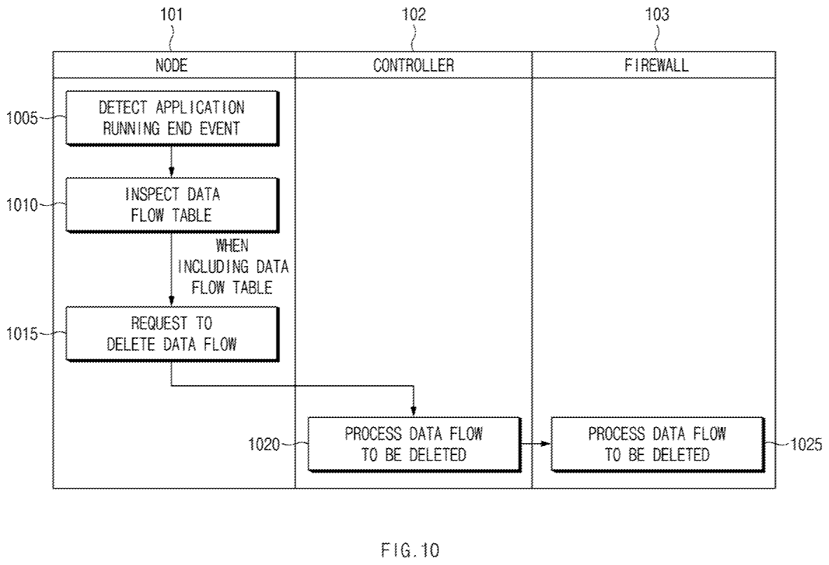

FIG. 10 illustrates a signal sequence diagram for ending application execution according to various embodiments.

In operation 1005, an access control application 111 of a node 101 may identify whether an application (e.g., a target application or an access control application) which is running in the node 101 is ended, that is, an application running end event in real time and may perform a data flow table inspection procedure when the application is ended.

In operation 1010, it may be identified whether there are identification information of the ended application and process ID and child process ID tree (PID) information in a data flow table.

In operation 1015, when there are the identification information of the ended application and data flow corresponding to the PID in the data flow table, the corresponding data flow may be deleted.

When the ended application is not present in a list of processes which are running to track the end of multiple executable applications, all data flow corresponding to the identification information of the ended application may be deleted.

The access control application may transmit a list of the deleted data flow to a controller to request deletion.

In operation 1020, the controller may delete corresponding data flow from the data flow table based on the list of the deleted data flow, which is received from the terminal, and may transmit the list of the deleted data flow to a firewall 103. Furthermore, the controller may collect a firewall policy from the node 101, thus preventing a malicious node from subsequently attempting to access the firewall.

In operation 1025, the firewall 103 may process a data packet corresponding to a source IP address, a destination IP address, and destination port information included in the list of the deleted data flow to be no longer forwarded.

The above description is merely an illustrative explanation of the technical idea disclosed in the present disclosure, but may be variously modified and altered by those skilled in the art to which the present disclosure pertains without departing from the spirit and scope of the present disclosure claimed in the following claims.

Therefore, the embodiments of the present disclosure are provided to explain the spirit and scope of the present disclosure, but not to limit them, so that the spirit and scope of the present disclosure is not limited by the embodiments. The scope of protection of the technical idea disclosed in the present disclosure should be interpreted in accordance with the claims below, and all the technical ideas within the scope equivalent to the claims should be included in the scope of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A network system, comprising:
a node including a communication circuit, a processor operatively connected with the communication circuit, and a memory storing an access control application;
a destination network the node wants to access;
a network node located between the node and the destination network and configured to include a memory; and
a server including a communication circuit, a processor operatively connected with the communication circuit, and a memory storing a database, the server being communicatively connected with the node and the network node,
wherein the node is configured to:
transmit or drop a data packet depending on whether there is data flow based on identification information of a target application or identification information including an IP address and port information of the destination network to communicate with the destination network, by means of the access control application;
transmit identification information of a terminated application to the server, when a termination of execution of the target application is detected;
wherein the server is configured to:
transmit information for deleting a data flow corresponding to the identification information of the terminated application to the network node;
wherein the network node is configured to:
delete data flow corresponding to the information for deleting the data flow.

2. The network system of claim 1, wherein the server is configured to:
identify whether identification information of the access control application is included and whether it is accessible to a network node present between the destination network mapped to the identification information and a network boundary of the node, in an access policy matched with the identification information on control flow;
identify whether it is accessible to a network node at the boundary of the destination network the node wants to access in the network node policy to grant access of the node, when it is accessible, and identify whether there is data flow accessible to the IP address and a port of the destination network in a data flow table;
generate data flow based on the IP address of the node, the IP address of the destination network, the port information, and data packet inspection information to grant access of the application, when there is no valid data flow in the data flow table, and transmit the generated data flow to the network node and the node; and
transmit data flow to the node, when there is the accessible data flow in the data flow table.

3. The network system of claim 1, wherein the network node is configured to:
identify whether there is data flow in a data table stored in the database, based on the IP address of the node, the IP address of the destination network, and the port information, among data packets received from the node;
drop the received data packet, when there is no the data flow;
identify the data packet is included in an inspection target based on a data packet inspection rule database (DB) included in the data flow, when there is the data flow;
forward the data packet, when it is not included in the inspection target; and
perform data packet processing, when it is included in the inspection target.

4. The network system of claim 3, wherein the data packet processing includes:
inspecting whether a single data packet is identical based on the data packet inspection rule database, when a single inspection of the data packet is performed;
storing the transmitted data packet in the memory of the network node up to a data packet transmission end point, when multiple inspections of the data packet are performed, and inspecting whether all the stored data packets are identical based on the data packet inspection rule database; and
processing a data packet, a pattern of which is detected, depending on data packet inspection information, when it is identical to the data packet inspection rule database, and
wherein the processing of the data packet includes:
dropping the data packet, when the data packet should be blocked;
replacing the data packet based on replacement information included in the data flow and forwarding the replaced data packet, when there is a need to replace the data packet; and
storing the data packet in the memory of the network node depending on a rule included in the data flow and forwarding the data packet, when there is a need to store the data packet.

5. The network system of claim 4, wherein the network node is further configured to:
transmit a data packet inspection result to the server.

6. The network system of claim 2, wherein the node is configured to:
receive a first user input for requesting user authentication; and
request user authentication for a user of the node from the server, using the communication circuit, the user authentication request including user identification information, and
wherein the server is configured to:
inspect whether the user who attempts access at the node is an accessible user and whether the user is included in a blacklist to identify the user is blocked, in response to the user authentication request from the node;
transmit inaccessible information to the node, when the user is inaccessible or when the user is included in the blacklist;
search a control flow table for control flow using transmitted control flow identification information, when the user is the accessible user, and add the user identification information to identification information of the found control flow; and
return an authentication complete state and access policy information of an authenticated user to the node as a user authentication result.

7. The network system of claim 1, wherein the node is configured to:
detect a control flow update event and request the server to update control flow; and
end the application or block all network access of the application, when the result of updating the control flow is inaccessible,
wherein the server is configured to:
identify whether there is control flow in a control flow table based on control flow identification information requested by the node;
return inaccessible information to the node, when there is no the control flow; and
update an update time, when there is the control flow, and search for data flow dependent on the control flow.

8. The network system of claim 1, wherein the node is configured to:
detect an access release event and request the server to end control flow,
wherein the server is configured to:
remove control flow identified and found based on control flow identification information requested by the node; and
request the network node for relaying all dependent data flow to remove data flow, when the control flow is removed, and
wherein the network node is configured to:
remove the data flow, such that the application is in a state in which it is no longer able to transmit the data packet to the destination network.

9. The network system of claim 1, wherein the access control application of the node is further configured to:
delete all data flow corresponding to identification information of the ended application, when the ended application is not present in a list of processes which are running to track the end of multiple executable applications.
